(19) United States
(12) Patent Application Publication
(10) Pub. No.: US 2026/0051728 A1
(43) Pub. Date: Feb. 19, 2026

(54) SHORT-CIRCUIT PROTECTION CIRCUIT AND LIGHTING DEVICE

(71) Applicant: SHENZHEN BILLDA TECHNOLOGY CO.,LTD, SHENZHEN (CN)

(72) Inventors: JIANJUN KE, SHENZHEN (CN); WEICHANG WU, SHENZHEN (CN); PEIZHI CHEN, SHENZHEN (CN); QIU FENG, SHENZHEN (CN)

(21) Appl. No.: 18/941,238

(22) Filed: Nov. 8, 2024

(30) Foreign Application Priority Data
Aug. 14, 2024 (CN) 202421973052.2

(51) Int. Cl. H02H 3/08; F21S 9/02; H02H 3/32

(52) U.S. Cl. CPC H02H 3/08; F21S 9/022; H02H 3/325

(57) ABSTRACT

The invention provides a short-circuit protection circuit and a lighting device. A control circuit comprises a thyristor and a switch transistor. A comparison circuit is electrically connected to a power supply, one terminal of a current sampling circuit and one terminal of the thyristor, the other terminal of the current sampling circuit is electrically connected to a first terminal of the switch transistor, a second terminal of the switch transistor is electrically connected to a second terminal of the thyristor, a third terminal of the switch transistor is electrically connected to an external load. By adopting the invention, the thyristor can be kept in an on-state to control on-off of the switch transistor so as to ensure that the switch transistor can be completely turned off, thus effectively improving the validity and reliability of short-circuit protection.

### BACKGROUND OF THE INVENTION

### 1. Technical Field

The invention relates to the technical field of circuits, in particular to a short-circuit protection circuit and a lighting device.

### 2. Description of Related Art

When a power supply system supplies power to a load, a power supply circuit may be short-circuited or a fault may happen to the load, leading to damage to the load or the power supply system. To avoid such a situation, short-circuit protection is often set in the power supply circuit to realize power switching in case of an overcurrent of the circuit. In the related art, when an overcurrent is detected by current sampling, a short-circuit protection circuit will control a connection switch of the circuit to be turned off to disconnect the power supply circuit from the load. However, because the triode will give a response instantly when driven, it will be instantly turned on when driven and instantly turned off when stopped from being driven; if the drive time is too short, the connection switch of the circuit may fail to be completely turned off, leading to low reliability of short-circuit protection.

### BRIEF SUMMARY OF THE INVENTION

The invention provides a short-circuit protection circuit and a lighting device to solve the problem of low reliability of short-circuit protection circuits in the related art.

To solve the abovementioned technical problem, in a first aspect, the invention provides a short-circuit protection circuit, comprising a comparison circuit, a current sampling circuit and a control circuit, wherein the control circuit comprises a thyristor and a switch transistor, the comparison circuit is electrically connected to a power supply, one terminal of the current sampling circuit and a first terminal of the thyristor, the other terminal of the current sampling circuit is electrically connected to a first terminal of the switch transistor, a second terminal of the switch transistor is electrically connected to a second terminal of the thyristor, and a third terminal of the switch transistor is electrically connected to an external load.

Further, the comparison circuit comprises a reference voltage supply circuit, a comparator, a first resistor, a second resistor, a third resistor and a first capacitor, a forward input terminal of the comparator is electrically connected to one terminal of the third resistor, one terminal of the first capacitor and one terminal of the current sampling circuit, a reverse input terminal of the first capacitor is electrically connected to one terminal of the reference voltage supply circuit, an output terminal of the comparator is electrically connected to the other terminal of the third resistor, one terminal of the first resistor and one terminal of the second resistor, a power terminal of the comparator, the other terminal of the first resistor and the other terminal of the reference voltage supply circuit are electrically connected to the power supply, the other terminal of the second resistor is electrically connected to the thyristor, and the other terminal of the first capacitor is grounded.

Further, the interference rejection circuit comprises a tenth resistor and a second capacitor, one terminal of the tenth resistor and one terminal of the second capacitor are electrically connected to the first terminal of the thyristor, and the other terminal of the tenth resistor and the other terminal of the second capacitor are grounded.

Further, the short-circuit protection circuit further comprises a voltage stabilizing circuit, and the voltage stabilizing circuit is electrically connected to the power supply and the comparison circuit.

Further, the voltage stabilizing circuit comprises a triode, a stabilivolt, a diode, an eleventh resistor and a twelfth resistor, a collector of the triode is electrically connected to a positive pole of the diode, an emitter of the triode is electrically connected to one terminal of the eleventh resistor and the comparison circuit, a base of the triode is electrically connected to a first terminal of the stabilivolt, a negative pole of the diode is electrically connected to the power supply, a second terminal of the stabilivolt is electrically connected to the other terminal of the eleventh resistor and one terminal of the twelfth resistor, and a third terminal of the stabilivolt and the other terminal of the twelfth resistor are grounded.

In a second aspect, the invention provides a lighting device, comprising the short-circuit protection circuit in the first aspect of the invention.

From the above description, a current in a power supply circuit is sampled by the current sampling circuit and compared by the comparison circuit, and a short-circuit protection signal is output to the control circuit in case of a short circuit of the power supply circuit, and after receiving the short-circuit protection signal, the control circuit disconnects the power supply circuit from a load to realize short-circuit protection; wherein, after receiving the short-circuit protection signal, the thyristor of the control circuit will be kept in an on-state to ensure that the switch transistor is completely turned off, thus improving the validity and reliability of short-circuit protection.

### BRIEF DESCRIPTION OF THE SEVERAL VIEWS OF THE DRAWINGS

FIG. 1 is a schematic circuit diagram of a short-circuit protection circuit according to one embodiment of the invention;

FIG. 2 is a schematic circuit diagram of the short-circuit protection circuit according to one embodiment of the invention;

FIG. 3 is a schematic circuit diagram of another short-circuit protection circuit according to one embodiment of the invention.

FIG. 4 is a schematic circuit diagram of a power supply system of a lighting device according to one embodiment of the invention.

### DETAILED DESCRIPTION OF THE INVENTION

To gain a better understanding of the purposes, technical solutions and advantages of the invention, the invention is described in further detail below in conjunction with accompanying drawings and embodiments, and identical or similar reference signs indicate identical or similar elements or elements with identical or similar functions throughout the description. It should be understood that the specific embodiments described here are merely used for explaining the invention and are not intended to limit the invention. In addition, the technical features involved in the embodiments of the invention can be combined without conflicts.

In view of the problem of low reliability of short-circuit protection caused by incomplete turn-off of a switch transistor of short-circuit protection circuits in the related art, one embodiment of the invention provides a short-circuit protection circuit.

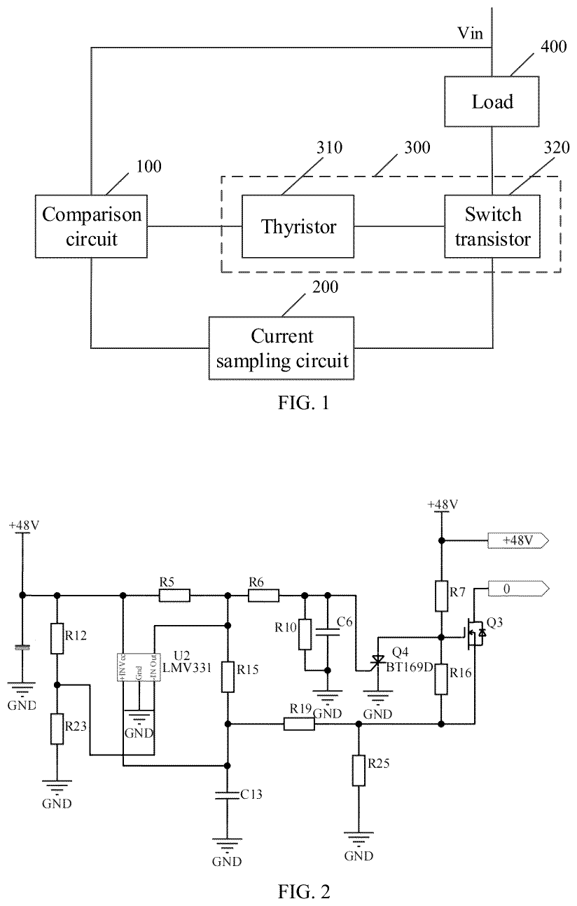

As shown in FIG. 1 which is a schematic circuit diagram of a short-circuit protection circuit according to one embodiment of the invention, the short-circuit protection circuit comprises: a comparison circuit 100, a current sampling circuit 200 and a control circuit 300, wherein the control circuit 300 comprises a thyristor 310 and a switch transistor 320; the comparison circuit 100 is electrically connected to a power supply, one terminal of the current sampling circuit 200 is electrically connected to a first terminal of the thyristor 310, the other terminal of the current sampling circuit 200 is electrically connected to a first terminal of the switch transistor 320, a second terminal of the switch transistor 320 is electrically connected to a second terminal of the thyristor 310, and a third terminal of the switch transistor 320 is electrically connected to an external load 400.

Specifically, in this embodiment, the current sampling circuit 200 acquires a current in a power supply circuit and transmits the current to the comparison circuit 100, and the comparison circuit 100 determines whether the power supply circuit is short-circuited; when the power supply circuit is short-circuited, the comparison circuit 100 outputs and transmits a short-circuit protection signal to the control circuit 300, and the control circuit 300 disconnects the power supply circuit from the load 400; wherein, when receiving the short-circuit protection signal transmitted from the comparison circuit 100, the thyristor 310 in the control circuit 300 will be kept in an on-state until it receives an off signal to completely turn off the switch transistor 320 to ensure that the power supply circuit is completely disconnected from the load 400, thus realizing short-circuit protection and improving the validity and reliability of short-circuit protection.

Referring to FIG. 2 which is a schematic circuit diagram of the short-circuit protection circuit according to this embodiment, the comparison circuit 100 comprises a reference voltage supply circuit, a comparator U2, a first resistor R5, a second resistor R6, a third resistor R15 and a first capacitor C13, wherein a forward input terminal of the comparator U2 is electrically connected to one terminal of the third resistor R15, one terminal of the first capacitor C13 and one terminal of the current sampling circuit 200, a reverse input terminal of the comparator U2 is electrically connected to one terminal of the reference voltage supply circuit, an output terminal of the comparator U2 is electrically connected to the other terminal of the third resistor R15, one terminal of the first resistor R5 and one terminal of the second resistor R6, a power terminal of the comparator U2, the other terminal of the first resistor R5 and the other terminal of the reference voltage supply circuit are all electrically connected to the power supply, the other terminal of the second resistor R6 is electrically connected to the thyristor 310 (Q4), and the other terminal of the first capacitor C13 is grounded.

Specifically, the reference voltage supply circuit comprises a fourth resistor R12 and a fifth resistor R23, wherein one terminal of the fourth resistor R12 is electrically connected to the power supply, the other terminal of the fourth resistor R12 is electrically connected to the reverse input terminal of the comparator U2 and one terminal of the fifth resistor R23, and the other terminal of the fifth resistor R23 is grounded.

In this embodiment, the reverse input terminal of the comparator U2 is used for receiving a reference voltage, the forward input terminal of the comparator U2 is used for receiving a feedback voltage transmitted from the current sampling circuit 200 to the power supply circuit, and the comparator U2 compares the feedback voltage with the reference voltage; if the feedback voltage is higher than the reference voltage, the comparator U2 outputs a short-circuit protection signal, such as high-level signal, to the control circuit 300 by means of the second resistor R6.

Further, referring to FIG. 2, the control circuit 300 further comprises a sixth resistor R7 and a seventh resistor R16; the switch transistor 320 (Q3) is an NMOS transistor, one terminal of the sixth resistor R7 is electrically connected to the power supply, the other terminal of the sixth resistor R7 is electrically connected to a gate of the NMOS transistor, the second terminal of the thyristor Q4 and one terminal of the seventh resistor R16, the other terminal of the seventh resistor R16 is electrically connected to a source of the NMOS transistor, and a third terminal of the thyristor Q4 is grounded.

Further, referring to FIG. 2, the current sampling circuit 200 comprises an eighth resistor R19 and a ninth resistor R25, wherein one terminal of the eighth resistor R19 is electrically connected to the comparation circuit 100, the other terminal of the eight resistor R19 is electrically connected to one terminal of the ninth resistor R25 and the source of the NMOS transistor, and the other terminal of the ninth resistor R25 is grounded.

Further, referring to FIG. 2, the control circuit 300 further comprises an interference rejection circuit, which is electrically connected to the first terminal of the thyristor Q4. Wherein, the interference rejection circuit comprises a tenth resistor R10 and a second capacitor C6, wherein one terminal of the tenth resistor R10 and one terminal of the second capacitor C6 are electrically connected to the first terminal of the thyristor Q4, and the other terminal of the tenth resistor R10 and the other terminal of the second capacitor C6 are grounded.

Specifically, in this embodiment, the switch transistor Q3 may be an MOS transistor such as an NMOS transistor in FIG. 2; when determining that an output current is too large (the power supply circuit short-circuited), the comparator U2 outputs a high-level signal to the thyristor Q4 by means of the second resistor R6 to turn on the thyristor Q4 to pull down the voltage of the gate of the NMOS transistor so as to turn off the NMOS transistor; after being triggered, the thyristor Q4 can still be kept in an on-state even if it is not driven anymore, thus ensuring that the switch transistor Q3 can be completely turned off. The sixth resistor R7 and the seventh resistor R16 are used for providing a bias voltage for the switch transistor Q3 to ensure that the switch transistor Q3 operates within a normal range and can prevent static electricity to avoid electrostatic damage in case of a high resistance between the gate and the source so as to ensure the safety of a device. The eighth resistor R19 and the ninth resistor R25 are used for acquiring a current of the source of the switch transistor Q3, converting the current into a voltage and transmitting the voltage to the forward input terminal of the comparator U2. The tenth resistor R10 and the second capacitor C6 are used for rejecting an interference signal to prevent the thyristor Q4 from being triggered spuriously, and the tenth resistor R10 is able to provide a discharge circuit.

Referring to FIG. 3 which is a schematic circuit diagram of another short-circuit protection circuit according to this embodiment, the short-circuit protection circuit further comprises a voltage stabilizing circuit, which is electrically connected to the power supply and the comparison circuit 100.

Specifically, the voltage stabilizing circuit comprises a triode Q2, a stabilivolt U3, a diode D2, an eleventh resistor R9 and a twelfth resistor R20, wherein a collector of the triode Q2 is electrically connected to a positive pole of the diode D2, an emitter of the triode Q2 is electrically connected to one terminal of the eleventh resistor R9 and the comparison circuit 100, a base of the triode Q2 is electrically connected to a first terminal of the stabilivolt U3, a negative pole of the diode D2 is electrically connected to the power supply, a second terminal of the stabilivolt U3 is electrically connected to the other terminal of the eleventh resistor R9 and one terminal of the twelfth resistor R20, and a third terminal of the stabilivolt U3 and the other terminal of the twelfth resistor R20 are grounded.

In this embodiment, to ensure that the comparator U2 can obtain a stable operating voltage to improve the stability of the short-circuit protection circuit, the short-circuit protection circuit is also provided with the voltage stabilizing circuit used for converting an input voltage and stabilizing the input voltage at an operating voltage, such as a 5V voltage, required by the comparison circuit 100, and the voltage stabilizing circuit is mainly formed by the stabilivolt U3, the diode Q2 and a sampling circuit; wherein, the eleventh resistor R9 and the twelfth resistor R20 sample a voltage input to the comparison circuit 100 and transmit the voltage to the stabilivolt U3, the stabilivolt U3 compares the sampled voltage with a reference voltage of itself, and then, an output of the triode Q2 is controlled to regulate the voltage of the comparison circuit 100. The diode D2 is used for limiting the voltage to ensure that the input voltage will not exceed a maximum permissible voltage of the stabilivolt U3 so as to protect the stabilivolt U3. The voltage stabilizing circuit further comprises a capacitor C4, a capacitor C5, a capacitor C9, a capacitor C7 and a resistor R8, wherein the resistor R8 is used for providing a bias voltage for the triode Q2, the capacitor C4, the capacitor C5 and the capacitor C7 are used for filtering, and the capacitor C9 is used for stabilizing a feedback loop.

According to the short-circuit protection circuit provided by the embodiments of the invention, the current sampling circuit acquires a current in a power supply circuit and transmits the current to the comparison circuit, and the comparison circuit determines whether the power supply circuit is short-circuited; when the power supply circuit is short-circuited, a short-circuit protection signal is transmitted to the control circuit, and the control circuit disconnects the power supply circuit from a load; wherein, when receiving the short-circuit protection signal transmitted from the comparation circuit, the thyristor in the control circuit will be kept in an on-state until it receives an off signal to completely turn off the switch transistor to ensure that the power supply circuit is completely disconnected from the load, thus realizing short-circuit protection and improving the validity and reliability of short-circuit protection.

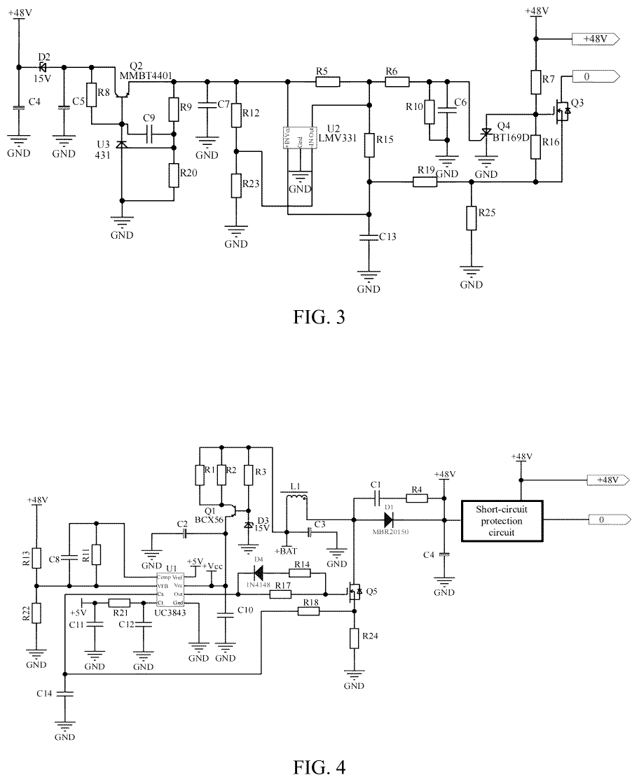

One embodiment of the invention further provides a lighting device, comprising the short-circuit protection circuit described above. Wherein, the lighting device may be an emergency light. The lighting device may further comprise a boost circuit, wherein the short-circuit protection circuit is connected between an output terminal of the boost circuit and a load, an input voltage of the short-circuit protection circuit is an output voltage (+48V in FIG. 2) of the boost circuit; and as shown by FIG. 4 which is a schematic circuit diagram of a power supply system of the lighting device, the boost circuit comprises a controller U1, an MOS transistor Q5 and a boost inductor L1, wherein an output pin of the controller U1 transmits a drive signal to the MOS transistor Q5 to turn on and off the MOS transistor Q5 periodically; in each on-off cycle, when the MOS transistor Q5 is turned on, the boost inductor L1 stores energy to boost an output voltage; and when the MOS transistor is turned off, the boost inductor L1 releases energy and transmits the energy to an external load such as an LED unit. A voltage feedback terminal of the controller receives a voltage sampled by a voltage sampling circuit, and a control voltage is generated by comparison to adjust the duty cycle or pulse width of the drive signal so as to control the on-time of the MOS transistor Q5 to regulate the output voltage. A current detection terminal of the controller receives a feedback voltage acquired by a current sampling circuit, and the duty cycle of pulse width of the drive control signal is adjusted according to the feedback voltage. The output voltage of the boost circuit is rectified by the diode D1 and then transmitted to the short-circuit protection circuit and the external load to provide a supply voltage for a device.

It should be noted that the embodiments of the application are described progressively, the differences of each embodiment from other embodiments are emphatically described, and the similarities between different embodiments can be referred to mutually.

It should also be noted that relational terms “first” and “second” in the invention are merely used for distinguishing one entity or operation from the other entity or operation and do not definitely require or imply that an actual relationship or sequence exists between these entities or operations. In addition, terms “comprise” and “include” or any other variants intend to indicate non-exclusive inclusion, so a process, method, article or device comprising a series of elements not only comprises the elements that are clearly listed, but also comprises other elements that are not clearly listed or comprises inherent elements of the process, method, article or device. Unless otherwise further defined, an element defined by “comprise one...” shall not exclude other identical elements in a process, method, article or device comprising said element.

With reference to the description of the above embodiments, those skilled in the art can implement or use the application. Various modifications of these embodiments will be obvious for those skilled in the art, and the general principle defined by the contents of the application can be implemented in other embodiments without departing from the spirit or scope of the application. Therefore, the application will not be limited to the embodiments illustrated here and has a broadest range in conformity with the principle and novel features disclosed by the application.

What is claimed is:

1. A short-circuit protection circuit, comprising a comparison circuit, a current sampling circuit and a control circuit, wherein the control circuit comprises a thyristor and a switch transistor, the comparison circuit is electrically connected to a power supply, one terminal of the current sampling circuit and a first terminal of the thyristor, the other terminal of the current sampling circuit is electrically connected to a first terminal of the switch transistor, a second terminal of the switch transistor is electrically connected to a second terminal of the thyristor, and a third terminal of the switch transistor is electrically connected to an external load.

2. The short-circuit protection circuit according to claim 1, wherein the comparison circuit comprises a reference voltage supply circuit, a comparator, a first resistor, a second resistor, a third resistor and a first capacitor, a forward input terminal of the comparator is electrically connected to one terminal of the third resistor, one terminal of the first capacitor and one terminal of the current sampling circuit, a reverse input terminal of the first capacitor is electrically connected to one terminal of the reference voltage supply circuit, an output terminal of the comparator is electrically connected to the other terminal of the third resistor, one terminal of the first resistor and one terminal of the second resistor, a power terminal of the comparator, the other terminal of the first resistor and the other terminal of the reference voltage supply circuit are electrically connected to the power supply, the other terminal of the second resistor is electrically connected to the thyristor, and the other terminal of the first capacitor is grounded.

3. The short-circuit protection circuit according to claim 2, wherein the reference voltage supply circuit comprises a fourth resistor and a fifth resistor, one terminal of the fourth resistor is electrically connected to the power supply, the other terminal of the fourth resistor is electrically connected to the reverse input terminal of the comparator and one terminal of the fifth resistor, and the other terminal of the fourth resistor is grounded.

4. The short-circuit protection circuit according to claim 1, wherein the control circuit further comprises a sixth resistor and a seventh resistor, the switch transistor is an NMOS transistor, one terminal of the sixth resistor is electrically connected to the power supply, the other terminal of the sixth resistor is electrically connected to a gate of the NMOS transistor, a second terminal of the thyristor is electrically connected to one terminal of the seventh resistor, the other terminal of the seventh resistor is electrically connected to a source of the NMOS transistor, and a third terminal of the thyristor is grounded.

5. The short-circuit protection circuit according to claim 4, wherein the current sampling circuit comprises an eighth resistor and a ninth resistor, one terminal of the eighth resistor is electrically connected to the comparison circuit, the other terminal of the eighth resistor is electrically connected to one terminal of the ninth resistor and the source of the NMOS transistor, and the other terminal of the ninth resistor is grounded.

6. The short-circuit protection circuit according to claim 1, wherein the control circuit further comprises an interference rejection circuit, and the interference rejection circuit is electrically connected to the first terminal of the thyristor.

7. The short-circuit protection circuit according to claim 6, wherein the interference rejection circuit comprises a tenth resistor and a second capacitor, one terminal of the tenth resistor and one terminal of the second capacitor are electrically connected to the first terminal of the thyristor, and the other terminal of the tenth resistor and the other terminal of the second capacitor are grounded.

8. The short-circuit protection circuit according to claim 1, further comprising a voltage stabilizing circuit, wherein the voltage stabilizing circuit is electrically connected to the power supply and the comparison circuit.

9. The short-circuit protection circuit according to claim 8, wherein the voltage stabilizing circuit comprises a triode, a stabilivolt, a diode, an eleventh resistor and a twelfth resistor, a collector of the triode is electrically connected to a positive pole of the diode, an emitter of the triode is electrically connected to one terminal of the eleventh resistor and the comparison circuit, a base of the triode is electrically connected to a first terminal of the stabilivolt, a negative pole of the diode is electrically connected to the power supply, a second terminal of the stabilivolt is electrically connected to the other terminal of the eleventh resistor and one terminal of the twelfth resistor, and a third terminal of the stabilivolt and the other terminal of the twelfth resistor are grounded.

10. A lighting device, comprising the short-circuit protection circuit according to claim 1.
